(19) United States
(12) Patent Application Publication
(10) Pub. No.: US 2009/0087507 A1
(43) Pub. Date: Apr. 2, 2009

(54) MOLD BASE FOR A THERMOPLASTIC CONTAINER MANUFACTURING MOLD, AND MOLDING DEVICE EQUIPPED WITH AT LEAST ONE MOLD PROVIDED WITH SUCH A BASE

(75) Inventors: Laurent Penet, Octeville-Sur-Mer (FR); Sylvain Meillerais, Octeville-Sur Mer (FR)

Correspondence Address: SUGHRUE MION, PLLC, 2100 PENNSYLVANIA AVENUE, N.W., SUITE 800, WASHINGTON, DC, 20037, US

(73) Assignee: SIDEL PARTICIPATIONS, OCTEVILLE-SUR-MER (FR)

(21) Appl. No.: 12/279,911

(22) PCT Filed: Feb. 13, 2007
(86) PCT No.: PCT/FR2007/000252

§ 371 Date: Aug. 19, 2008

(30) Foreign Application Priority Data
Feb. 20, 2006 (FR) 06 01482

(51) Int. Cl. B29C 49/42

(52) U.S. Cl. 425/117

(57) ABSTRACT

The invention concerns a mold base (1) for a mold for blow- or stretch-blow molding thermoplastic containers with petal-shaped base; the mold base (1) comprises several cavities (11) separated by radiating ridges(13) with concave crest surface (14), the bases of the cavities (11) being distributed in a circular outline; the crests (14) of the ridges extending in an arc from the center of the molding cavity (C); each zone (18) intermediate between two consecutive ridges (13) and a corresponding cavity (11) is flat in a plane (P) perpendicular to the axis (12) of the mold base (1); advantageously the cavities (11) are arc-shaped in the diametrical cross-section of the mold base.

### CROSS REFERENCE TO RELATED APPLICATION

This application is a National Stage of International Application No. PCT/FR2007/000252 filed Feb. 13, 2007, claiming priority based on French Patent Application No. 06 01482, filed Feb. 20, 2006, the contents of all of which are incorporated herein by reference in their entirety.

### FIELD OF THE INVENTION

The present invention relates generally to the field of manufacturing, by blow molding or stretch blow molding, containers, in particular bottles, made of thermoplastic material such as PET.

More specifically, the invention relates to improvements made to the design of a mold base for a mold for manufacturing, by blow molding or stretch blow molding, containers, in particular bottles, made of thermoplastic material such as PET, said containers having a body and having a base of the type known as petaloid with a plurality of feet which are distributed at an angle in an equidistant manner, which extend approximately parallel to the axis of the container and which are separated from one another by radiating troughs with a bottom extending in a curved convex manner, said mold base having a mold cavity comprising, for the molding of said base of the containers, a plurality of cavities which are distributed at an angle in an equidistant manner, which extend approximately parallel to the axis of the mold base and which are separated from one another by radiating ridges with crests extending in a circular arc from the center of the mold cavity, the bottoms of said cavities being distributed over a substantially circular contour having a given base diameter.

The term “ridge” is understood to denote one projecting part, substantially radially elongated, of the mold base which leads, in the base of the molded container, to the formation of said one “trough”.

### BACKGROUND OF THE INVENTION

The part of the containers which is the most awkward to manufacture is the base. More specifically, it is the base of the container which supports the weight of the column of liquid contained in the container and, in the case of where it has insufficient mechanical resistance, it loses its shape and the container may no longer rest in a stable manner on a support.

However, precisely in order that it may have the desired mechanical resistance, the base has a substantial wall thickness, proportionally greater than that of the remainder of the container. As a result, it requires relatively more material than the body of the container, the wall thereof currently attaining a very low thickness which becomes difficult to reduce. The base thus forms the part of the container of which the correct shaping is the most difficult to implement by the blow molding or stretch blow molding operation, due to the fact that the substantially greater thickness of material leads to slower stretching and more difficult shaping. More specifically, to improve the mechanical resistance thereof, the base generally has a complex, even very complex, shape with numerous hollow and projecting relief portions of which the correct shaping leads to the desired mechanical resistance.

The difficulties and drawbacks explained above, which are of a general nature, are further worsened in the case of containers provided with bases of complex shape with multiple projecting feet, known as “petaloid” bases. Indeed, these petaloid bases have on the periphery alternating raised portions projecting substantially axially forming feet and hollows or “troughs” separating them, the bottoms of these troughs extending approximately radially over a hemispherical outer contour: the stretching, in particular in the axial direction, of the material during the blow molding process is thus very wide-ranging, depending on whether there are raised portions or troughs. However, at whichever location of the base, it is necessary for the mechanical resistance to be sufficient to avoid the weakening of the base under the action of the weight of the liquid and the internal pressure (this type of container often being intended to contain carbonated liquids), which is ensured by providing a substantially increased thickness of material. Moreover, the complex shape of the petaloid bases requires a high degree of control of the blow molding conditions, and in particular of the blow molding pressure, to achieve the shaping of the correct container bases.

Also noteworthy, as regards more particularly petaloid bases, is the very large angular path to which the material has to be subjected during deformation, leading from the hemispherical shape of the base of the initial preform to the wall of reverse orientation (resting on an approximately conical surface) defining the foot toward the center of the finished container; depending on the location, the material may be subjected to an angular path which is able to reach 90°, or even more. This, associated with the particular thickness of the material in this zone, may lead to insufficient flattening of the material onto the wall of the mold cavity and to poor cooling of the material against the mold; a lower quality of the base or of certain parts of the base of the container may result. Moreover, this large angular path of the material requires a significant length of time.

More specifically, manufacturers of thermoplastic containers seek to improve in a permanent manner the costs of production, by attempting to produce containers requiring a lower quantity of thermoplastic material, at a blow molding pressure which is if possible substantially lower (liable to cause insufficient flattening of the material against the mold) and above all with even higher production rates (requiring during molding that the material unrolls more rapidly, which is difficult to achieve for the thickest parts of the base).

### SUMMARY OF THE INVENTION

The object of the invention is to propose an improved solution which makes it possible to manufacture containers with a petaloid base in improved conditions, eliminating the aforementioned drawbacks whilst being compatible with an increase in production rates desired by manufacturers.

To this end, according to a first of its aspects, the invention proposes a mold base for a mold for manufacturing, by blow molding or stretch blow molding, containers, in particular bottles, made of thermoplastic material such as PET, as mentioned in the preamble, said mold base being characterized, being arranged according to the invention, in that the mold base has intermediate zones which are each defined between two consecutive ridges and the cavity located between these two ridges and which are substantially planar in a plane substantially perpendicular to the axis of the mold base.

The structure of the mold base which has been disclosed above is remarkably simple from the point of view of its geometry in comparison with the very complex shapes of the petaloid bases manufactured until now. In particular, it will be noted that the stretching of the material is less than in the previous bases and that, in the central part of the mold cavity comprising the planar portions of the intermediate zones, the material is more easily flattened against the mold wall and thus more easily cooled. Moreover, the angular path of at least certain parts of the material of the base of the preform, during its unrolling during molding, is considerably reduced relative to the previous process and thus requires less time: this is advantageous within the context of seeking a higher production rate.

Advantageously, the cavities have a substantially circular arc shape in the diametrical cross section of the mold base. However, to obtain sufficiently stable support of the feet on a support it is desirable, in a manner which is moreover already known per se, that the cavities of the mold base used for molding the feet of the containers are substantially elongated in a circumferential direction. Thus arranged, the feet of the containers are in the form of circumferentially elongated spherical caps; these large shapes with relatively large radii of curvature of the mold base make the feet of the containers able to be molded more easily than the narrow feet with small radii of curvature of conventional petaloid bases.

Advantageously, it may also be provided that the edge of each cavity is connected to the substantially planar portion of the respective intermediate zone by means of a circular arc-shaped fillet, having substantially the same radius as the radius of the cavity observed in diametrical cross section of the mold base. In the mold base thus formed, all the curved surfaces have large radii of curvature which here again, promotes correct and rapid molding of the material.

In practice, it may be provided that the radial extent of a cavity is approximately equal to half of the radial extent of said intermediate zone, such that the quantity of material having to undergo maximum stretching, which is necessary for the formation of each foot is thus reduced, at the same time as the planar surface portions which are able to be observed in the central part of the mold base are unobstructed.

If reference is made to the geometry of the base of the preforms used for the manufacture of containers, it is preferably provided that the radial dimension of each substantially planar intermediate zone is substantially proportional to the diameter of the manufactured container; in particular the ratio of the diameter of the circular distribution contour of the bottoms of the cavities of the mold base (which corresponds to the diameter of the resting region of the manufactured container) to this radial dimension of each substantially planar intermediate zone is between approximately 3 and 2.5, preferably between approximately 2.8 and 2.7. In other words, the material of the thick base of the preforms only undergoes minimum stretching and is simply unrolled onto the planar portions of the intermediate zones of the mold cavity, such that the initial thickness of the material of the base of the preforms is not stretched in the corresponding planar portions of the base of the containers.

A mold base arranged according to the invention makes it possible to manufacture containers having bases of simplified shape in a large dimensional range and in improved conditions in terms of improving the conditions of shaping the bases of the containers and increasing the rates of manufacture, in particular, of large-capacity containers (for example 1.5 to 3 liters), all features which perfectly meet the expectations of practical experience.

According to a second of its aspects, the invention also proposes a molding device for manufacturing, by blow molding or stretch blow molding, containers, in particular bottles, made of thermoplastic material such as PET, said containers having a body and having a base of the type known as petaloid, with a plurality of feet which are distributed at an angle in an equidistant manner, which extend approximately parallel to the axis of the container and which are separated from one another by radiating troughs with a convex bottom, said molding device comprises at least one mold consisting of at least three parts including one mold base having a mold cavity comprising, for the molding of said base of the containers, a plurality of cavities which are distributed at an angle in an equidistant manner, which extend approximately parallel to the axis of the mold base and which are separated from one another by radiating ridges with crests extending in a circular arc from the center of the mold cavity, the bottoms of said cavities being distributed over a substantially circular contour, which molding device, being arranged according to the invention, is characterized in that the mold base is arranged according to the invention as explained above. One important application of the features of the invention relates to rotating blow molding or stretch blow molding machines of the carousel type provided with a plurality of molds having respective bases arranged according to the invention.

### BRIEF DESCRIPTION OF THE INVENTION

The invention will be better understood by reading the detailed description which follows of certain preferred embodiments thereof, given solely by way of purely illustrative example. In this description, reference is made to the accompanying drawings, in which:

FIG. 1 is a view from above of a mold base arranged according to the invention;

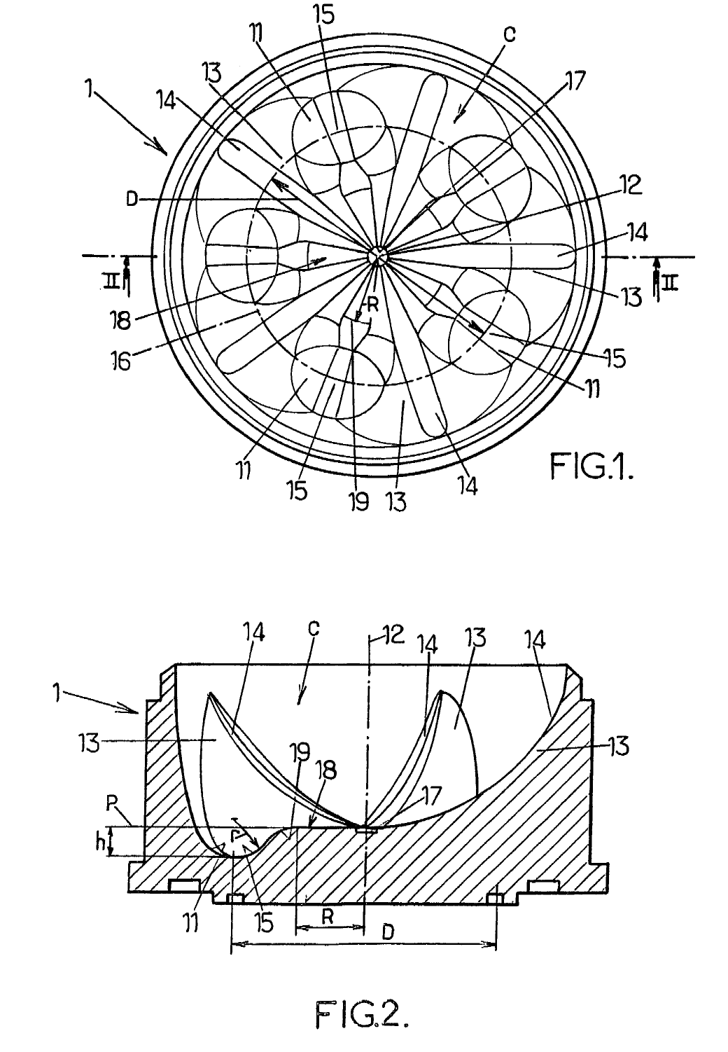

FIG. 2 is a view in diametrical cross section along the line II-II of the mold base of FIG. 1;

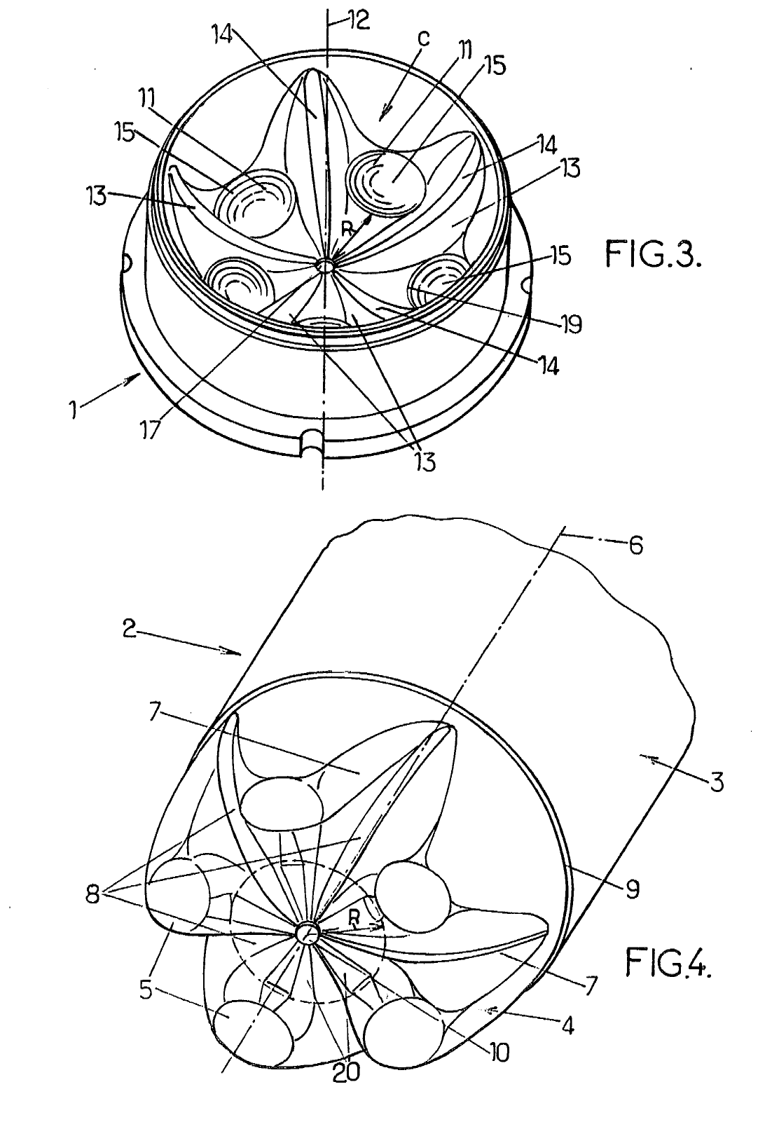

FIG. 3 is a perspective three quarter view through the top of the mold base of FIG. 1; and

FIG. 4 is a perspective three quarter isometric view from below of the base of a molded container with a mold base arranged according to FIGS. 1 to 3.

### DETAILED DESCRIPTION OF THE INVENTION

Referring now to FIGS. 1 to 3, a mold base 1 is shown there which is intended to provided a mold for manufacturing, by blow molding or stretch blow molding, containers, in particular bottles, made of thermoplastic material such as PET.

As shown in FIG. 4, the containers 2 having to be manufactured with this mold have a body 3 and have a base 4 of the type known as petaloid having a plurality of projections forming feet 5, generally a number between three and seven, in practice between four and six (five in the illustrated example) which are distributed at an angle in an equidistant manner, which extend approximately parallel to the axis 6 of the container and which are separated from one another by radiating troughs 7 with a bottom 8 extending in a curved convex manner. All the troughs 7 converge at the center of the base which consists of a projection in the form of a central, circular plate 10, projecting to the outside. The base 4 of the container is connected to the body 3 of the container through a connecting zone 9 which is substantially cylindrical in revolution.

The mold base 1 is provided with a mold cavity C which comprises, for molding said base 4 of the containers 2, a plurality of cavities 11 in a number equal to the number of feet 5 of the base 4, generally between three and seven, in practice between four and six (five in the example illustrated in FIGS. 1 to 3) which are distributed at an angle in an equidistant manner (mutual angular distance of 72° in this example) which extend approximately parallel to the axis 12 of the mold base 1 (which is also the axis of the mold cavity C) and which are separated from one another by radiating ridges 13 (i.e. the parts, elongated substantially radially, projecting from the mold cavity C which lead, in the base 4 of the molded container, to the formation of said troughs 7).

Each ridge 13 has a crest 14 extending in a concave manner, in the form of a circular arc centered on the axis 12 of the mold base and originating from this axis 12.

The bottoms 15 of the cavities 11 are distributed on a substantially circular contour 16 having a given base diameter D, this diameter corresponding to the diameter of the resting portion of the base 4 of the containers (diameter of the circular contour on which are distributed the zones of the feet 5, by means of which the containers rest on a planar support).

The center of the mold cavity C comprises a circular depression 17 of shallow depth of which the dimensions are adapted to receive the projecting part of the bases of the initial preforms, corresponding to their injection-molding point, which makes it possible to facilitate the formation of said plate 10 of the container base 4 allowing correct centering of the preforms.

According to the invention, the intermediate zones 18 which are each defined between two consecutive ridges 13 and the corresponding cavity 11 located between these two ridges and which are substantially planar in a plane P substantially perpendicular to the axis 12 of the mold base 1 and thus tangent to said crests 14 at the center of the mold base.

Also, as is seen most clearly in the view in diametrical section of the mold base of FIG. 2, each cavity 11 advantageously has a substantially circular arc-shaped radial section with a radius r whilst it is enlarged in the circumferential direction so that on the base of the respective foot 5 of the container a resting part is defined having a sufficient width to allow the container to be supported in a stable manner on a planar support. The height h of the cavities 11 is substantially less than their radius r, such that each cavity 11 thus shaped has approximately the shape of a spherical cap, stretched circumferentially as visible in FIGS. 1 and 3.

Moreover, the edge of each cavity 11 is connected to the respective substantially planar intermediate zone 18 by a circular arc fillet 19 having substantially the same radius r as the radius of the cavity viewed in diametrical section of the mold base, as visible in FIG. 2. Thus connections of small radius are avoided, which facilitates improved flattening of the material against the mold wall.

In the preferred embodiment illustrated in FIGS. 1 to 3, the radial extent of a cavity 11 in one respective intermediate zone 18 represents approximately half of the radial extent of said intermediate zone 18. Advantageously, the radial dimension R of each substantially planar intermediate zone 18 is proportional to the diameter of the manufactured containers; in particular, if reference is made to the diameter D of the circular contour on which are distributed the bottoms 15 of the cavities 11 of the mold base 1 as explained above (and which corresponds to the resting diameter or diameter of the distribution contour of the feet 5 of the finished container) the ratio D/R of this diameter D to said radial dimension R of the substantially planar intermediate zones 18 is between approximately 3 and 2.5, preferably between approximately 2.8 and 2.7. Thus during molding, in these intermediate zones 18, the base of the preform is substantially flattened perpendicular to the axis 12 of the mold base 1 without being substantially stretched radially. The material is subjected to displacement within a range which is less than that during the molding of conventional petaloid bases in which the corresponding zones rest on a downwardly-open truncated contour and the material is thus flattened more easily against the mold wall, which leads to its improved cooling.

Referring to FIG. 4, it is seen that in a container base 4 manufactured using a mold base according to the invention, the troughs 7 which extend as far as the center of the base 4 of the container (as far as the central projecting plate 10) mutually define, behind the feet 5 toward the center of said base 4, portions 20 of approximately triangular and substantially planar shape, within a substantially circular contour (in dashed lines on FIG. 4) of which the radius has said value R.

The features according to the invention find a most particularly preferred application in a molding device for manufacturing, by blow molding or stretch blow molding, containers 2, in particular bottles, made of thermoplastic material such as PET, said containers 2 having a body 3 and having a base 4 of the type known as petaloid with a plurality of feet 5 which are distributed at an angle in an equidistant manner, which extend approximately parallel to the axis 6 of the container and which are separated from one another by radiating troughs 7 with a bottom 8 extending in a curved convex manner, which molding device comprises at least one mold consisting of at least three parts including one mold base 1 comprising, for the molding of said base 4 of the containers, a plurality of cavities 11 which are distributed at an angle in an equidistant manner, which extend approximately parallel to the axis 12 of the mold base 1, and which are separated from one another by radiating ridges 13 with crests 14 extending in a circular arc from the center of the mold cavity, the bottoms 15 of said cavities 11 being distributed over a substantially circular contour having a given base diameter D, the mold base 1 of said at least one mold of the molding device being thus designed with one and/or other of the arrangements explained above. In particular, such a molding device may in practice be in the form of a rotating blow molding or stretch blow molding machine of the carousel type provided with a plurality of molds, having respective bases arranged according to the invention.

1.-8. (canceled)

9. A mold base for a mold for manufacturing, by blow molding or stretch blow molding, containers, in particular bottles, made of thermoplastic material such as PET, said containers having a body and having a base of the type known as petaloid with a plurality of feet which are distributed at an angle in an equidistant manner, which extend approximately parallel to the axis of the container and which are separated from one another by radiating troughs with a bottom extending in a curved convex manner, said mold base having a mold cavity comprising, for the molding of said base of the containers, a plurality of cavities which are distributed at an angle in an equidistant manner, which extend approximately parallel to the axis of the mold base and which are separated from one another by radiating ridges with crests extending in a circular arc from the center of the mold cavity, the bottoms of said cavities being distributed over a substantially circular contour,
wherein said mold base has intermediate zones which are each defined between two consecutive ridges and the cavity located between these two ridges and which are substantially planar in a plane substantially perpendicular to the axis of the mold base.

10. The mold base as claimed in claim 9, wherein said cavities have a substantially circular arc shape in the diametrical cross section of the mold base.

11. The mold base as claimed in claim 9, wherein the radial extent of a cavity is approximately equal to the radial extent of said intermediate zone.

12. The mold base as claimed in claim 9, wherein the edge of each cavity is connected to the respective substantially planar intermediate zone by means of a circular arc-shaped fillet which has substantially the same radius as the radius of the cavity viewed in the diametrical cross section of the mold base.

13. The mold base as claimed in claim 9, wherein the ratio of the diameter of the circular distribution contour of the bottoms of the cavities of the mold base to the radial dimension of each substantially planar intermediate zone is between approximately 3 and 2.5.

14. The mold base as claimed in claim 13, wherein said ratio is between approximately 2.8 and 2.7.

15. The mold base as claimed in claim 9, wherein said cavities are substantially elongated in a circumferential direction.

16. A molding device for manufacturing, by blow molding or stretch blow molding, containers, in particular bottles, made of thermoplastic material such as PET, said containers having a body and having a base of the type known as petaloid, with a plurality of feet which are distributed at an angle in an equidistant manner, which extend approximately parallel to the axis of the container and which are separated from one another by radiating troughs with a convex bottom, which molding device comprises at least one mold consisting of at least three parts including one mold base having a mold cavity comprising, for the molding of said base of the containers, a plurality of cavities which are distributed at an angle in an equidistant manner, which extend approximately parallel to the axis of the mold base and which are separated from one another by radiating ridges with crests extending in a circular arc from the center of the mold cavity, the bottoms of said cavities being distributed over a substantially circular contour, wherein said mold base is arranged according to claim 9.
